(19) United States
(12) Patent Application Publication
(10) Pub. No.: US 2025/0377960 A1
(43) Pub. Date: Dec. 11, 2025

(54) CONTINUOUS DATA CONTENT INTEGRITY COMPROMISE DETECTION WITH ERROR HANDLING

(71) Applicant: Dell Products L.P., Round Rock, TX (US)

(72) Inventors: Elik Levin, Modi'in (IL); Jehuda Shemer, Kfar Saba (IL); Gaurav Chawla, Austin, TX (US); Arthur Lent, Newton, MA (US)

(21) Appl. No.: 18/735,993

(22) Filed: Jun. 6, 2024

(51) Int. Cl. G06F 11/07; G06F 21/56

(52) U.S. Cl. CPC G06F 11/0751; G06F 21/561

(57) ABSTRACT

A detection engine for handling communication errors while performing threat detection in a computing system is disclosed. The detection engine includes an interceptor that is positioned in a data path and configured to intercept IOs. The interceptor transmits a data stream, which may include data and/or metadata or the intercepted IOs, to a detector. The detector perform a detection analysis. When a threat is detected, a response may be initiated. When a communication error is present with respect to the detection engine, the interceptor may perform error handling operations. The error handling operations may store tracking data that allow the detector to catch-up with respect to the detection analysis when the communication error is resolved.

### TECHNOLOGICAL FIELD OF THE DISCLOSURE

Embodiments disclosed herein generally relate to protecting computing systems and data of computing systems. More particularly, at least some embodiments relate to systems, hardware, software, computer-readable media, and methods for detecting malicious actions or threats in computing systems.

### BACKGROUND

One of the problems or threats facing entities today relates to malware. Many entities rely on computing systems and data for a wide variety of reasons. From an individual perspective, a person's livelihood and assets can be attacked. From an entity perspective, user privacy, business operations, company secrets, and the like can be compromised.

Many entities today are attacked daily. Networks are continually being probed for weaknesses, malicious emails are frequently received, and other attack vectors are used daily. As a result, protecting computing systems against malware requires vigilance. In addition to known malware, new malware is being released seemingly continuously. Protection is achieved by regularly updating protection systems so that newer defenses are available. But the problem of malware does not just go away.

Conventionally, methods for protecting computing systems against malware include scanning disks or filesystems in an attempt to find malware that may be present. One of the drawbacks to these methods is the time required to perform the detection operations. Scanning a disk requires access to the disk, time to read and process the data or information stored on the disk. As the size of the data grows, detection operations can consume even more time. Additionally, these methods may interfere with normal use of the disk and can potentially delay or disrupt normal operations.

Optimizations to existing methods include scanning data represented by the delta between a current scan and a previous scan. From a practical perspective. these scans are run once a day or every 6-12 hours. More specifically, even with delta optimizations, time is required to access the data, identify the data corresponding to the delta, copy the delta, expose the copied data, analyze the copied data, etc. Even if malware is discovered, significant damage may be done in the computing system before the attack is detected and countermeasures are deployed.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of detecting malware in a computing system, a computing device, or a computing environment;

FIG. 2A discloses aspects of detecting malware in the context of a virtual machine system using a detection engine that includes an interceptor and a detector;

FIG. 2B discloses aspects of installing an interceptor in a computing system;

FIG. 2C discloses additional aspects of an interceptor;

FIG. 3A discloses aspects of an interceptor operating in a synchronous mode;

FIG. 3B discloses aspects of an interceptor operating in an asynchronous mode;

FIG. 3C discloses aspects of an interceptor operating in an out of band mode;

FIG. 4 discloses aspects of error handling in the context of a detection engine that includes an interceptor and a detector operating in a computing system;

FIG. 5 discloses aspects of a tracked error recovery operation; and

FIG. 6 discloses aspects of a computing system, device, or entity.

### DETAILED DESCRIPTION OF SOME EXAMPLE EMBODIMENTS

Embodiments disclosed herein generally relate to protecting computing systems and related data. More particularly, at least some embodiments relate to systems, hardware, software, computer-readable media, and methods for detecting threats, such as malware, and/or remediating the threat.

As used herein, malware is an example of a threat and malware refers to various types of malicious software, operations, actions, and/or actors. Examples of malware may include, but are not limited to, ransomware, viruses, worms, spyware, adware, rootkits, fileless malware, grayware, keyloggers, viruses or the like or combinations thereof. While embodiments of the invention are discussed generally with respect to malware such as ransomware, detecting different types of malware may be performed in different manners. From a general perspective, malware such as a virus is detected by searching for code or signatures of the malware. As a result, searching for virus may focus on searching a computer system. Detecting ransomware, in contrast, may focus on detecting changes in the data caused or performed by the ransomware. Changes that may indicate ransomware include encryption or obfuscation, file deletion, read patterns to detect exfiltration, or the like. As a result, the focus, when detecting ransomware, may be on data storage.

A search for ransomware (and malware in general) may also look for side effects of the ransomware's existence. Side effects may include leftover files, configuration changes, and the like. Detecting ransomware using the side effects also focuses on the storage.

Embodiments of the invention relate to a datacenter scale ransomware detection paradigm that is disconnected from the actual storage medium on which the data is stored. Ransomware can be detected, in accordance with embodiments of the invention, based on the data path. Thus, an interceptor that is configured to detect or aid in the detection of ransomware may be place or located in hypervisors, in storage arrays, or other infrastructure.

Generally, embodiments of the invention relate to a detection engine that may include an interceptor and a detector. The interceptor may be configured to operate in the data path (e.g., read/write or IO (Input/Output) path). This allows IOs to be intercepted as the IOs are occurring. The data, metadata, or portions thereof intercepted by the interceptor, may be transmitted to the detector for analysis. This allows malware to be detected in real-time, near real time, or with lower latency than conventional systems. The detector may be configured to generate alerts, trigger responses, or the like. The response actions may include commands to the interceptor. Thus, the interceptor may be configured to both intercept IOs and perform response actions in a computing system and more specifically in the data path.

In some examples, an error condition or communication error may be present in a manner that may prevent effective communication between the detector and the interceptor. Embodiments of the invention further relate to error handling operations that allow a detection engine to perform a detection or threat analysis on data that was read/written while the error condition existed. The interceptor, for example, may perform error handling operations that include generating tracking data that identifies the relevant IOs that occurred during the error condition. The detection engine, once the error condition is resolved, can perform threat detection on the IOs that occurred during the error condition using the tracking data. This can be performed for both reads and writes together or separately.

Embodiments of the invention may be implemented in various computing configurations and computing systems. Embodiments of the invention may be implemented in the context of a single device or machine (e.g., a desktop, laptop, or server computer), physical systems, storage arrays, local storage, distributed storage, virtual systems, a cluster of servers, networks, an edge environment, a datacenter (the cloud), or the like. A computing system, in addition, may include or be associated with multiple interceptors, multiple detectors and may operate in a distributed and/or coordinated manner in one example.

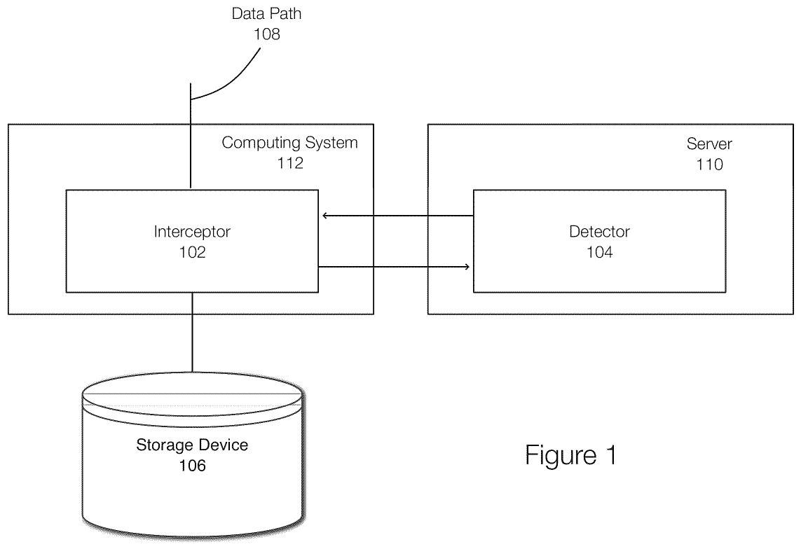

FIG. 1 discloses aspects of detecting malware in a computing system, computing device, or computing environment using a detection engine that includes an interceptor and a detector. FIG. 1 illustrates an interceptor 102 installed in a computing system 112. The interceptor 102 is placed in the data (or IO) path 108 and is configured to intercept IOs (e.g., reads/writes) occurring in the computing system 112. The IOs, in this example, are performed with respect to a storage device 106. The storage device 106 is representative of various storage types or representations such as edge/cloud storage, block storage, a filesystem, a volume, network storage, virtual storage, object storage, or other storage devices or the like or combinations thereof.

When an IO is intercepted, the interceptor 102 may communicate the IO (or portion thereof) to the detector 104, which may operate on a server 110. The server 110 may be in a local area network with the computing system 108, may be part of the computing system 108, or may be remote, such as in a datacenter or edge system.

The interceptor 102 may be configured to transmit a data stream (or package) to the detector 104. The contents of the data stream can be customized or determined by the detector 104. For example, the data stream may include a copy of the IO's data, metadata of the IO, or the like. The data stream may include information or data representative of multiple IOs. The detector 104 is configured to analyze the contents of the data stream and perform an action when malware (or other threat such as an unauthorized change by an authorized user) is suspected or detected.

Generally stated, the interceptor 102 transmits a data stream to the detector 104. The data stream may include the metadata and/or data of the IOs in the data path 108 that are intercepted by the interceptor 102. The data stream may also include or alternatively include processed data such as hashes, checksums, searched subsets, or the like or combinations thereof.

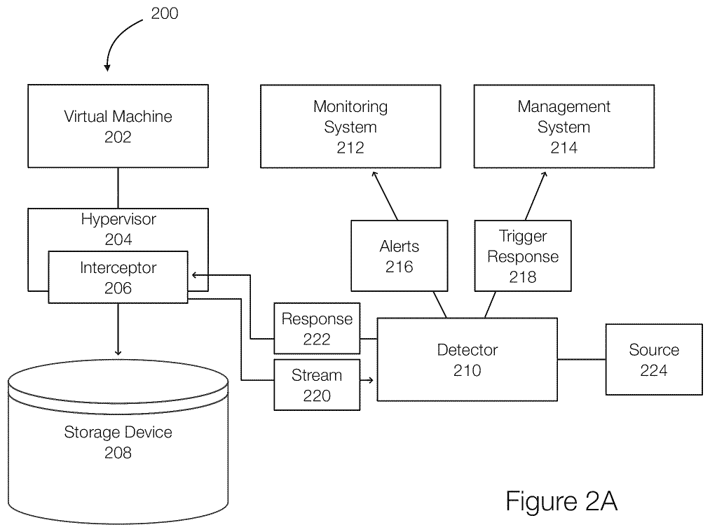

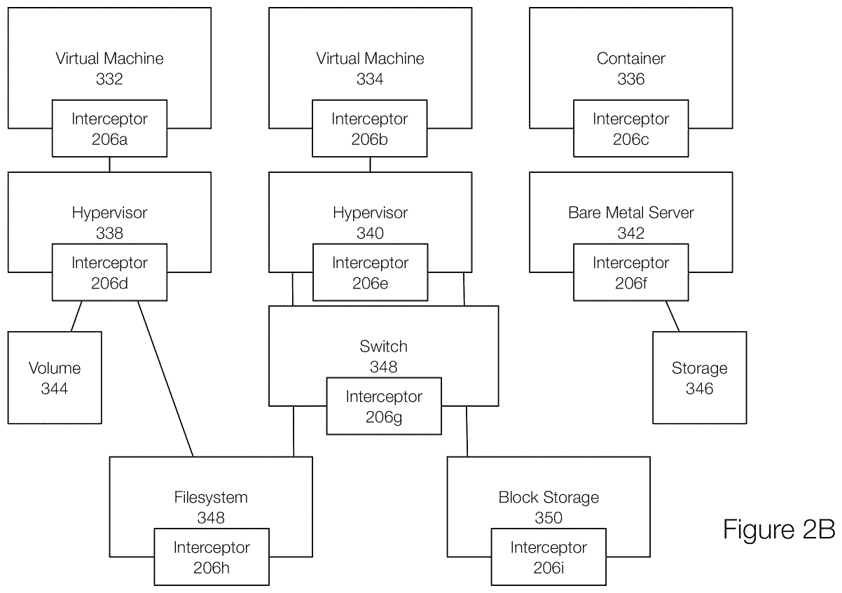

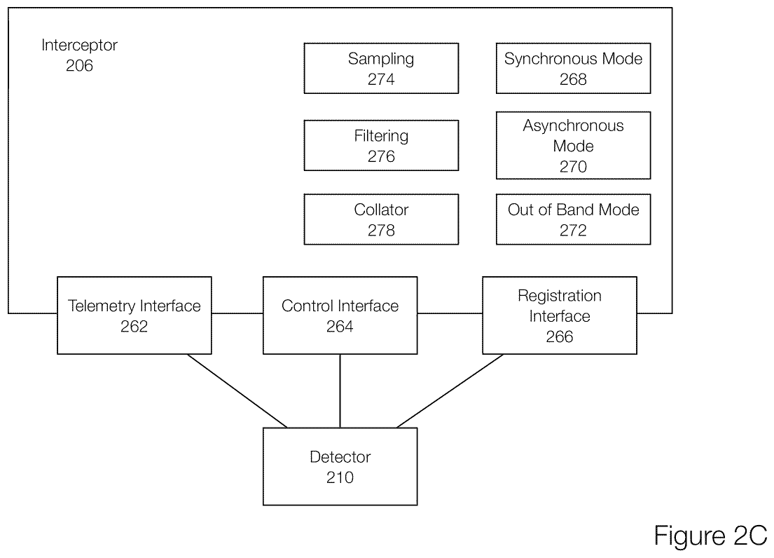

FIG. 2A discloses aspects of detecting malware in the context of a virtual machine environment. FIG. 2A illustrates a computing system 200 that includes a virtual machine 202 that is associated with a storage device 208 (e.g., a volume or virtual disk). An interceptor 206 is installed or located in a hypervisor 204 in this example.

The interceptor 206 is configured to intercept IOs as the IOs pass through the system 200 at the hypervisor 204 layer. The interceptor 206 may send a data stream 220 (or package) to a detector 210 for detection analysis. The detector 210 performs a detection operation on the data stream and based on the results of the detection operation, may generate alerts 216 that are provided to a monitoring system 212, which may be part of management system 214. The alerts 216 may trigger further investigation. The detector 210 may trigger a response 218 that is provided to the management system 214. The detector 210 may send a response 222 to the interceptor 206 and/or perform other remediation operations upon detecting a thread. The response 222 may instruct the interceptor 206 to take immediate action (e.g., prevent all IOs or specific IOs with respect to a particular process, volume, or the like). The trigger response 218 may also be provided to management 214, which may direct other protection operations to be performed in the system 200 and/or other aspects of a larger network.

More specifically, the detector 210 may have some control over the IO flow of the system 200 and can instruct the execution of certain actions with respect to the virtual machine 202, the storage device 208 or other aspects of the system 200. The interceptor 206 may be instructed or controlled to respond to threats identified in the system 200. The operations performed by the interceptor 206 may be determined or instructed by the detector 210.

The detector 210 is configured to analyze (e.g., perform a detection operation to detect malware or other threat) the data stream 220. The detector 210 may be configured to interface or connect with the interceptor 206. This allows the detector 210 to configure the interceptor 206. For example, the detector 210 may define the data/metadata to be collected from the IOs in the data path and included in the data stream 220. The detector 210 receives the data stream in accordance with the configuration of the interceptor 206 and performs an analysis on the data stream 220 looking for threats or malicious activity.

More specifically, the detector 210 receives streams of metadata and/or data from the interceptor 206 and analyzes the data stream to detect threats such as malware or other malicious activity. Threats can be related to ransomware, data corruption, or other security violations. When a threat is detected, different actions can be triggered as a response. For example, the detector 210 may generate alerts 216 such as notifying a management system or a SIEM/SOC (Security Information and Event Management/Security Operations Center). The detector 210 may open a ticket in a ticketing system. The trigger response 218 may be an automated response, a script, or procedure that is followed when a threat or a suspected threat is identified. The detector may generate the response 222, which is an action performed by the interceptor 206. The detector 210 may perform these actions individually or in combinations. Other protective actions may also be performed such as evicting processes, quarantining volumes, or the like.

The detector 210 may perform a detection operation or analysis in various manners. For example, the detector 210 may scan the data stream for specific data or for data patterns. The detector 210 may include an anomaly detection engine configured to detect anomalies or match anomalies. The detector 210 may include classifiers and other machine learning models trained to look for malicious patterns.

The detector 210 may perform data comparison. Data comparison may include comparing data (or signatures) between sources where the data is expected to be the same. For example, an upgrade may be applied to multiple locations in a short period of time. A threat may be present if this type of data does not match.

The detector 210 may identify a threat, a confidence level that the threat is real, and/or targeted metadata pointing to the location of the threat. In one example, an example response, performed by the interceptor 206 or the management system 214, is an escalation operation. This may include a more in-depth scan of the storage device 208 or volume area. A stop response may be an example of an interceptor intervention where IOs are stopped or quarantined.

Embodiments of the invention enable real-time detection with low latency. In some example, multiple IOs may be accumulated to obtain a better understanding of the threat or potential threat. Alternatively, the detector 210 may consult with external sources 224 when performing an analysis or detection operation. Thus, the detector 210 may include some resources, such as memory, that allow an analysis to be performed on multiple IOs, consecutive IOs, non-consecutive IOs, or the like.

FIG. 2B discloses aspects of installing and/or operating an interceptor in a computing environment. FIG. 2B illustrates an example computing system or computing environment that may include, by way of example only, virtual machines 332, 334, a container 336, hypervisors 338, 340 (which may be of different types) a bare metal server 342, volumes 344 and 346, a switch 348, a filesystem 348 and block storage 350.

Generally, the interceptor 206 can be placed in and configured for different locations of a data path as illustrated in FIG. 2B. The interceptor 206 can be adapted and configured for various locations as illustrated by interceptors 206a, 206b, 206c, 206d, 206e, 206f, 206g, 206h, and 206i. Each of these interceptors 206a, 206b, 206c, 206d, 206e, 206f, 206g, 206h, and 206i are adapted to or configured for their location or placement in the data path.

An IO may encounter multiple interceptors in some embodiments. Different interceptors may look at the same IO in different contexts and transformations. For example, a first interceptor may view encrypted and/or compressed data while a second interceptor in the data path of the IO may view decrypted and/or decompressed data. An interceptor may view data from the perspective of a logical address or a physical device address. An IO may be associated with different metadata at different times. For example, metadata associated with a user, process, operating system, or the like may be detected at different points of the data path.

Thus, an interceptor may located at, by way of example and not limitation, the operating system (user space or kernel space), embedded in the hardware IO devices, accelerator cards, CPUs, SmartNics, VM virtual hardware, container drivers, virtualized devices, hypervisors or container hosts, cloud infrastructure, storage arrays, storage devices, network or SAN switches, load balancers, or the like or combinations thereof.

As previously stated, the interceptor may be configured or adapted to the placement in the data path. The interceptor 206 may intercept data differently at different locations. In software locations, interfaces may be provided for filters that are configured to extract the relevant data from the IO.

In another example, a virtual device (FUSe) may be constructed to replace the original target device, receive the IOs, generate the data stream from the IO, and then forward the IO to the original device. Network and SAN (Storage Area Network) redirects may be used or included in an interceptor. Regardless of the implementation, placement, or configuration, IOs (reads and writes) may be funneled through the interceptor 206. Reads may not malicious, but read patterns may indicate malicious behaviors and may be analyzed.

Because an interceptor may require computing resources, embodiments of the invention may try to keep resource requirements (e.g., CPU (central processing unit), memory) low, although this may be balanced with desired capability.

FIG. 2C discloses additional aspects of an interceptor. As previously indicated, the interceptor 206 intercepts and feeds a data stream of metadata and/or data into the detector 210. The interceptor 206 provides or includes, in one example, a telemetry interface 262, a control interface 264, and a registration interface 266. Communication and data transmission between the interceptor 206 and the detector 210, control operations, and registration operations, occur over these interfaces.

The telemetry interface 262 is configured to send data streams (the content can be determined by the detector 210 or set by default) from the interceptor 206 to the detector 210. The transmission of the data stream may be performed using one or more modes, which may include a synchronous mode 268, asynchronous mode 270, and an out of band mode 272.

The control interface 264 enables the detector 210 (or a management system) to control or determine information that is sent by the interceptor 206. For example, the control interface 264 may be used control what (e.g., data and/or metadata) is sent to the detector 210. The control interface 264 allows the detector 210 so specify what data to extract or copy from the IOs in the data path.

For example, the package or data stream may be configured by default or by negotiation. The data type options include, by way of example only, the full IO (data and metadata), IO metadata (e.g., volume, location, length), a hash of the data, a filename or object identifier, security or access information, timestamps, counters, secondary information such as statistics, metric, function aggregates, writes only, reads only, reads and writes), or the like or combinations thereof.

When sending the full data, the payload may be large and may introduce some latency into the detection operation. However, malware or threats can often be detected from metadata alone. This reduces latency at least because metadata transmissions are smaller than full data transmissions. Thus, transmitting metadata alone can reduce latency in the detection operation. The interceptor 206 may also be configured to apply compression, encryption, authentication, or the like to improve performance and/or security.

The amount of data transmitted to the detector 210 can also be reduced using sampling 274 and filtering 276. For example, sampling 274 and/or filtering 276 may be performed to send data and/or metadata associated with specific volumes or entities. Thus, data may be filtered according to IO target. In another example, IOs are filtered such that only data directed to specific parts of a volume are transmitted to the detector (e.g., boot record and master file table area or IOs to the first megabyte of the volume). In another example, IOs longer/shorter than a predetermined size are transmitted.

In another example, the IOs are sampled in a time based manner. For example, transmissions from the interceptor 206 are time based (e.g., first 10 minutes of every hour, on weekends, during upgrades). In another example, a statistical sampling of an area or time is performed. In another filtering, example entities or IOs that includes an expression such as “database” are transmitted to the detector 210. In another example, the filtering 276 may be on the lookout for an expression, data pattern, or hash. Data is transmitted to the detector only when a match is found.

The interceptor 206 may optimize communications by collating the data to be transmitted using a collator 278. The collator 278 may aggregate multiple data points (IOs) and transmit the data points in bulk (and in order) rather than one by one. The interceptor 206 may collect data with the collator 278 until a threshold amount is collected or for a certain amount of time. The collator 278 may reduce context switching and reduce memory and CPU consumption.

By way of example and not limitation, if the interceptor 206 is configured to transmit metadata only, the transmission for an IO may be 32 bytes as follows: (Volume ID (16 bytes), Location (8 bytes), Length (8 bytes)). This is a small payload for every IO. However, if 128 IOs are collated by the collator 278, the payload may be 4 Kbytes. This reduces the IO load by two orders of magnitude. In one example, the collator 278 may wait until a threshold number of IOs are collected or for a specified time period. The data may also be compressed such that additional data may be accumulated by the collator 278.

The control interface 264 may also be used to instruct the interceptor 206 to perform an operation, such as a response to a detected threat. For example, the detector 210 or a management entity may send a command or response to cause the interceptor 206 deny IOs from a particular source or that are directed to a particular destination or target.

More specifically, the interceptor 206 may be used to respond to a perceived or actual threat. The response instructed by the detector 210 or management 214 may include an instruction to block all or some IOs, filter out IOs or some type of IOs, delay IOs to slow things down for detection and response reasons, redirect IOs to an alternate destination such as a sink hole or quarantine area, or the like or combinations thereof. The instruction may be to modify IOs (e.g., zero out sections, perform find/replace) Enabling the interceptor 206 to perform the instructed response may require an encrypted token signed by one or more administrators for security reasons.

The registration interface 266 allows the detector 210 to register with the interceptor 206. This may include security and authentication protocols. In fact, the registration, security, and/or authentication protocols may go either way: the detector 210 may register with the interceptor 206 or the interceptor 206 may register with the detector 210.

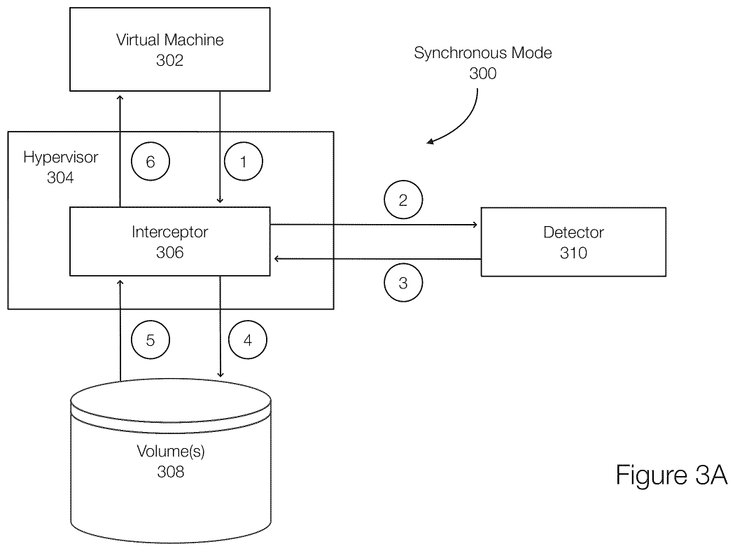

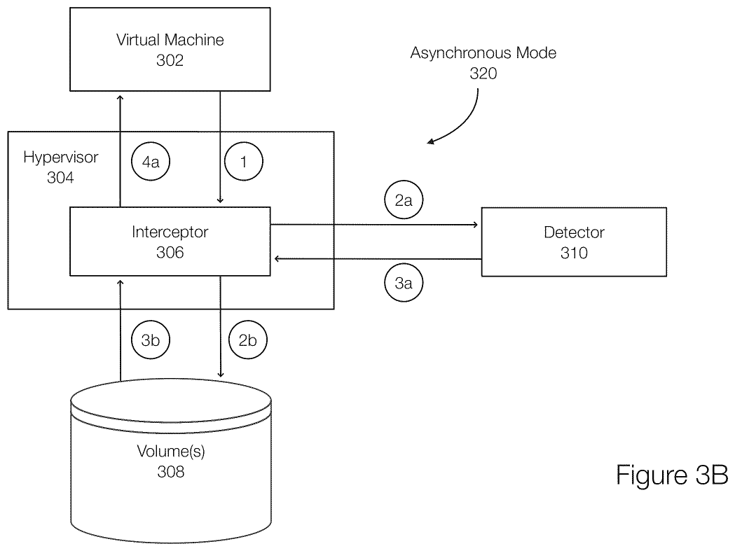

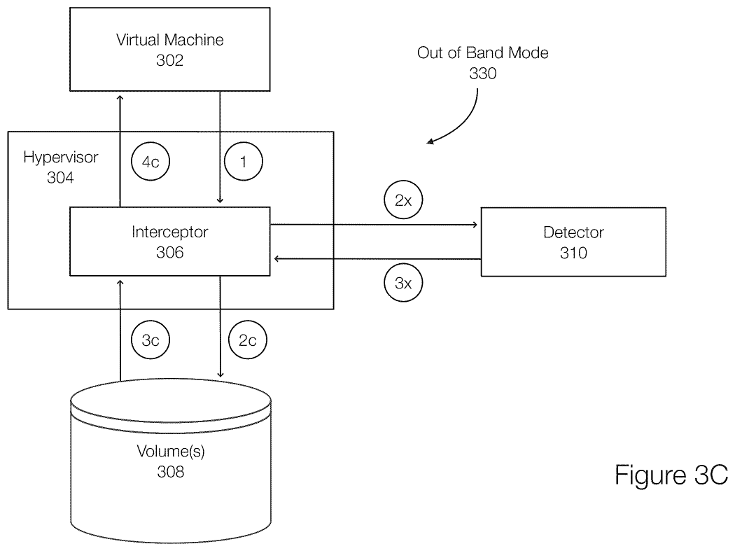

The control interface 264 is used by the detector 210 to select one of the modes 268, 270, 272, to configure how the intercepted data is transmitted to the detector 210. These are discussed with reference to FIGS. 3A-3C.

FIG. 3A discloses aspects of an interceptor operating in a synchronous mode. When operating in a synchronous mode 300, an intercepted IO is typically handled and processed by the detector 310 before being allowed to proceed to the volume 308 or other target. In this example, an IO (e.g., a write) transmitted from a virtual machine 302 is intercepted (1) by the interceptor 306 located in a hypervisor 304. The interceptor 306 may forward (2) the data of the IO and/or metadata (or other data related to the IO) to the detector 310. The detector 310 sends an acknowledgement (3) back to the interceptor 306. The acknowledgment (3) is sent after performing the detection operation in one example.

Once the acknowledgement (3) is received by the interceptor 306, the IO is allowed to proceed (4) to the volume 308. An acknowledgment (5) is returned to the interceptor 306 and an acknowledgment (6) is provided to the virtual machine 302.

The synchronous mode 300 provides the detector 310 with full control over the IOs in the data path before the IOs are transmitted to the target. If a threat is detected or suspected, the detector 310 can prevent the IO from being performed (e.g., block). For example, an IO may be blocked by preventing the acknowledgment (5). If the acknowledgment (5) is positive, the IO is permitted. If the acknowledgment (5) is negative (Nack), the IO is rejected and subsequent steps of sending the IO to the volume 308 is prevented.

The synchronous mode 300, however, may add some latency to the process associated with performing a detection operation. While the synchronous mode 300 is still close to real time (e.g., not hours later), the latency added to an IO relates to the time required to process the IO at the interceptor 306, transmit to the detector 310, perform the detection operation, and receive a response or an acknowledgement from the detector 310. If a response is sent instead of the acknowledgment, the response is performed. The acknowledgment, in one example, is a response that requires no further action. In one example, the latency is that the production system is being slowed down. Every IO, rather than directly hitting the storage, is processed by the interceptor and the detector. This may add, in some embodiments, latencies on the order of microseconds or milliseconds that may depend on processing and communication constraints.

FIG. 3B discloses aspects of an interceptor operating in an asynchronous mode. In the asynchronous mode 320, data is transmitted in a data path and intercepted (1) by the interceptor 306. In this example, the data and/or metadata is transmitted (2a) to the detector 310 while the IO is also transmitted (2b) to the volume 308. The transmissions (2a and 3a) may occur in parallel or at substantially the same time. The interceptor 306 does not wait for the acknowledgment (3a) from the detector to allow transmission (2b) of the IO to the volume 308.

In this example, both targets (detector 310 and volume 308) process the IO and return acknowledgments (3a and 3b). The initiator only sends the acknowledgment (4a) to the virtual machine 302 after both acknowledgments (3a and 3b) have been received. The latency in this example is the slower of the two IOs (2a and 2b) to the targets (detector 310 and volume 308). More specifically, the latency is from the beginning of 2a and 2b until the last of 3a and 3b acknowledgments are received.

The detector 310 has less control in the asynchronous mode 320 because the IO may have reached the volume 308 even if the detector 310 rejects the IO as a threat or potential threat. Thus, the response may also depend on the transmission mode. Data that may have been written to the volume 308 may require further remediation.

FIG. 3C discloses aspects of an interceptor operating in an out of band mode. In this example, no communication latency is added in the data path. Thus, data received from the virtual machine 302 is intercepted (1) by the interceptor 306 and is transmitted (2c) to the volume 308 without delay. The acknowledgment (3c) from the volume 308 to the interceptor 306 operating in the hypervisor 304 is followed by the acknowledgment (4c) to the virtual machine 302.

In the out of band mode 330, the transmission (2x) of data and/or metadata and the acknowledgment (3x) occur separately. In this mode, the detector 310 has no control over IOs, but has the smallest latency of the transmission modes.

Embodiments of the invention thus relate to an interceptor that can be placed in the data path within multiple system components. An IO stream can be transmitted to a detector that is configured to detect threats, generate alerts, escalate detection protocols, or block IOs. The actions performed in response to detecting a threat may vary and depend on the mode and the control over the data path. The synchronous mode may provide the most control, but may also introduce the most latency as IOs are stopped until an acknowledgment is received from the detector.

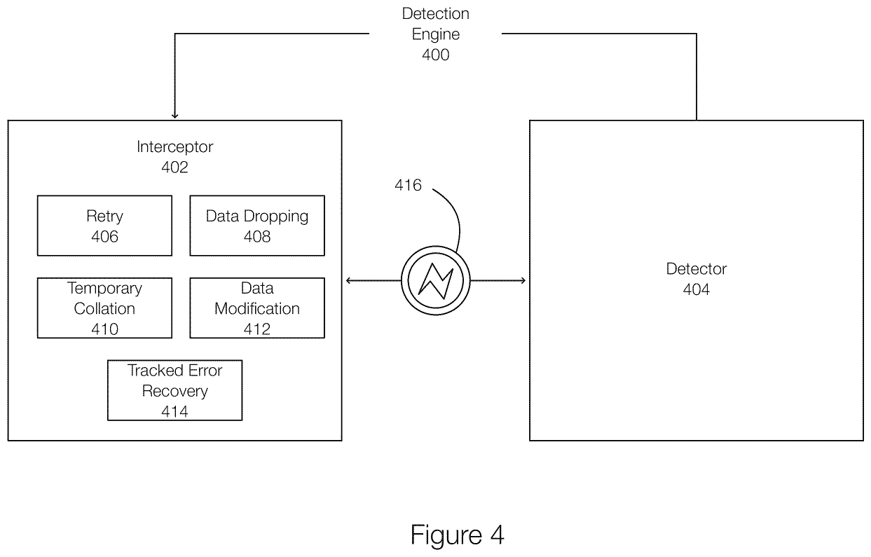

FIG. 4 discloses aspects of error detection in communications between an interceptor and a detector. In this example, a detection engine 400 that includes an interceptor 402 configured to cooperate with a detector 404 to perform error handling. When sending/receiving data to/from a detector, communication errors may be encountered. As previously stated, the detection engine may operate in different modes (e.g., synchronous, asynchronous, out of band). When communication errors are encountered, embodiments of the invention may attempt or retry the communication. This may result in increased or unacceptable latencies. The impact of the increased latency may depend on the mode of operation. Increased latencies are generally detrimental and embodiments of the invention may perform various error handling operations in order to prevent or minimize latency increased while balancing the ability of the detection engine 400 to perform malware detection.

In this example, a communication error 416 is detected and error handling operations may be invoked or initiated by the interceptor 402 in response to the communication error 416. The communication error 416 may be a disconnection, reduced bandwidth, network issues, or the like. In some examples, a communication error 416 may include detecting an increase in latency. More specifically, error handling operations may be performed in response to events that interrupt communications, delay communications, detector 404 failure, interceptor 402 failure, or the like.

In one example, if the detection engine 400 detects that latency is increasing, an error handling operation may be performed. The detection engine 400 may select a specific error handling operation based on the transmission mode, the amount of increased latency or the like. Selecting or performing an error handling operation may also be accompanied by a change in transmission mode.

A retry operation 406 is an example of error handling. Other error handling operations may be performed in addition to or in lieu of, retries.

Another example of an error handling operation is a data dropping operation 408. The data dropping operation 408 may be performed, by way of example only, when reduced latency is prioritized over analysis accuracy. In the data dropping operation 408, data to be transmitted may be dropped when sampling options are being used such that certain samples may not be transmitted.

In another example, a temporary collation operation 410 may be performed. The detection engine 400 may (or may not) generally employ collation or queueing in the context of data transmission. When communication errors occur, such as the communication error 416, temporary collation 410 may be used to accumulate or collate some of the data for sending at a later time. This may allow the interceptor 402 to still transmit data, for example, after the communication error is resolved.

In another example, a data modification operation 412 may be performed. For example, if the communication error 416 is a bandwidth issue, embodiments of the invention may send only the metadata rather than full data.

In another example, a tracked error recovery operation 414 may be performed. In some scenarios, error handling operations such as a retry operation 406 and a temporary collation operation 410 may not be viable options. More specifically and by way of example only, there may be a need to guarantee that data is analyzed even in the event of communication or transmission errors. If the detector 404 is down or there is a network failure, the latency may increase to unacceptable levels, memory may run out, or the like.

The tracked error recovery operation 414 is configured to ensure that the detection engine 400 can catch up even during long disruptions. The operation 414 ensures that the analysis of the detector 404 is performed and that full scans, which are often employed in these scenarios, can be avoided.

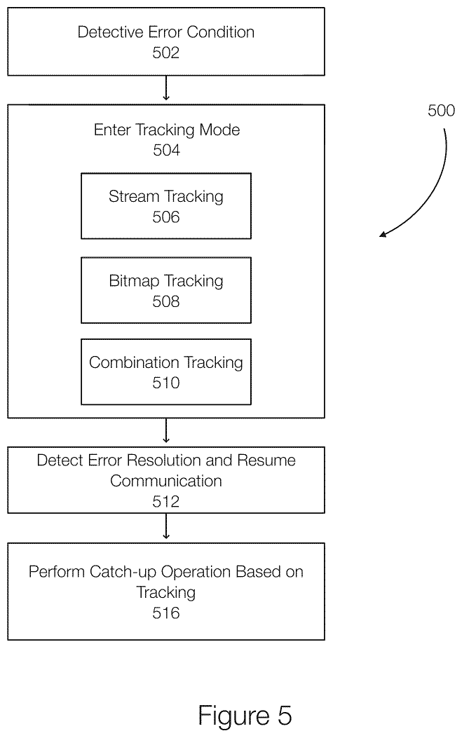

FIG. 5 discloses aspects of a tracked error recovery operation. A method 500 may include portions that may be performed independently. For example, a first portion of the method 500 may relate to performing the tracking operation in response to the error condition or communication error. A second portion of the method 500 may correspond to a catch up operation after the error condition or communication error is resolved.

The method 500 may begin when an error condition is detected 502. As previously stated, an error condition or communication error may be an increase in latency, detector failure, network failure, loss or reduction of bandwidth, or the like.

In one example, the interceptor 504 may enter 504 a tracking mode. Entering 504 the tracking mode, however, may occur only after other options have been attempted or if the error condition is not resolved within a predetermined amount of time. For example, the interceptor may enter 504 the tracking mode after a predetermined number of retries, or if memory is becoming unacceptably scarce, or the like.

Once the tracking mode is enabled, the interceptor stops sending data to the detector and begins storing locations to which data is being written. The locations may include an address and/or a length of the write, identify extents, or the like.

More specifically, a stream tracking mode 506 may be initiated. The stream tracking mode 506 may store locations as a stream of pairs (location, length). This may be enabled on a volume basis in one example The memory consumed by the stream may depend on the bytes used to represent each of the pairs. By way of example only, each pair may consume 16 bytes or less, 8 bytes or less, or the like. The stream tracking mode 506 provides high accuracy. However, the stream tracking mode 506 may run out of memory if the error condition is not resolved. The interceptor may use a bitmap tracking mode. In this example, a bitmap is allocated to match the device size. Thus, each bit in the bitmap (or array or other representation) may correspond to a specific disk chunk or extent (e.g., 64 KB). When data is written to a disk area, the corresponding bit is set to 1 to mark the area as dirty. The bitmap tracking 508 is not subject to running out of memory. However, the bitmap tracking mode 508 is not as precise as the stream tracking mode 506 and may have less granularity.

In some examples, a combination tracking mode 510 may be used. The interceptor may begin using the stream tracking mode 506. If more than a predetermined number of elements or pairs are accumulated, the interceptor may switch or shift to a the bitmap tracking mode 508.

In another example, reads and writes may be tracked separately.

In the method 500, error resolution may be detected and communication between the interceptor and the detector may resume 512. Once communication resumes, the tracking operation is terminated, subsequent IOs are handled normally, and a catch-up operation is performed 516 based on the tracking performed during the tracking mode.

More specifically, the catch-up operation may include the detector requesting the interceptor to retrieve the tracking information stored in the stream and/or the bitmap. The catch-up operation may be performed with respect to read IOs and write IOs.

With respect to read IOs, the interceptor may read tracking data or metadata using the stream and/or the bitmap. The tracking metadata for the read IOs may be translated into a metadata format expected by the detector. Alternatively, the tracking data for the read IOs may be prepared as a recovery mode payload. The detector is thus configured to handle a recovery mode payload and perform the malware detection analysis with regard to the read IOs. This ensures that the detector is able to catch-up and perform the analysis on all data that has been read from the target device(s).

The information required to analyze the write IOs may be acquired in a similar manner using the stream and/or the bitmap. When data, in addition to metadata, is required, the interceptor can read the last known data written to the volume or target. The tracking data allows the locations of the writes to be identified and the interceptor can access the target or volume because the interceptor is in the data path. Thus, the data can be read in bulk or in parts and transmitted to the detector for analysis.

In one example, the detection engine, once the error condition is resolved, perform both a current mode or operation and the catch-up operation. The detection engine can perform the malware detection analysis even during long disruptions, avoid missed analysis and avoid the need to perform full scans.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, data protection operations, IO interception operations, threat detection operations, ransomware detection operations, response operations, remediation operations, quarantine operations, eviction operations, error handling operations, tracked error recovery operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable perform operations initiated by one or more clients or other elements of the operating environment.

Example cloud computing environments, which may or may not be public, include storage environments that may provide data storage functionality for one or more clients. Another example of a cloud computing environment is one in which processing, data protection, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients that may be capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, appliances, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ is intended to be broad in scope. Example embodiments are applicable to any system capable of storing and handling various types of objects, in analog, digital, or other form.

It is noted that any operations of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method for performing protection in a computing system, the method comprising: detecting an error condition in a computing system by a detection engine that includes an interceptor positioned in a data path and a detector configured to perform threat detection, wherein the error condition impacts communication between the interceptor and the detector, entering an error handling mode, by the interceptor, based on the error condition, wherein interceptor is configured to store tracking data during the error handling mode associated with IOs (Input/Outputs) in the data path, resuming the communication between the interceptor and the detector when the error condition is resolved, and performing a catch-up operation using the tracking data such that the detector performs the threat detection based on the tracking data.

Embodiment 2. The method of embodiment 1, wherein the error condition includes an increase in latency, bandwidth reduction, failure of the detector, network failure, or combinations thereof, wherein the threat detection is configured to detect ransomware.

Embodiment 3. The method of embodiment 1 and/or 2, wherein the error handling mode comprises a tracking mode, further comprising entering the tracking mode only when the error condition lasts longer than a predetermined period of time or after a predetermined number retries have failed.

Embodiment 4. The method of embodiment 1, 2, and/or 3, wherein the error handling mode comprises a tracking mode, wherein the tracking mode comprises a stream tracking mode, wherein IOs are tracked in a stream by the interceptor, wherein the stream stores pairs that each include a location and a length.

Embodiment 5. The method of embodiment 1, 2, 3, and/or 4, wherein the error handling mode comprises a tracking mode, wherein the error tracking mode comprises a bitmap tracking mode, wherein IOs are tracked by the interceptor in a bitmap stored by the interceptor.

Embodiment 6. The method of embodiment 1, 2, 3, 4, and/or 5, wherein the error handling mode comprises a tracking mode, wherein the tracking mode comprises a stream tracking mode that uses a stream to track IOs and a bitmap tracking mode that uses a bitmap to track the IOs,, wherein the stream tracking mode transitions to the bitmap tracking mode based on resource availability.

Embodiment 7. The method of embodiment 1, 2, 3, 4, 5, and/or 6, wherein read IOs and write IOs are tracked separately by the error handling mode.

Embodiment 8. The method of embodiment 1, 2, 3, 4, 5, 6, and/or 7, wherein the error handling mode comprises a tracking mode configured to generate tracking data related to the IOs during the error condition, wherein the catch-up operation includes sending tracking data related to read IOs to the detector for the malware detection, wherein the tracking data is formatted for the detector.

Embodiment 9. The method of embodiment 1, 2, 3, 4, 5, 6, 7, and/or 8, wherein the catch-up operation includes generating a payload for tracking data related to the read IOs.

Embodiment 10. The method of embodiment 1, 2, 3, 4, 5, 6, 7, 8, and/or 9, wherein the error handling mode comprises a tracking mode configured to generate tracking data related to the IOs during the error condition, wherein the tracking data includes metadata and data read from locations on a target identified from the tracking data.

Embodiment 11. A non-transitory storage medium having stored therein instructions that are executable by one or more hardware processors to perform operations comprising the operations of any one or more of embodiments 1-10.

The embodiments disclosed herein may include the use of a special-purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general-purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special-purpose computer, or special-purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

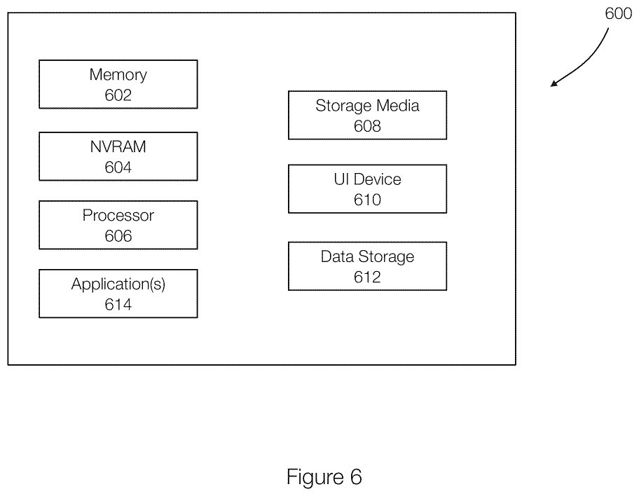

With reference briefly now to FIG. 6, any one or more of the entities disclosed, or implied the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for performing protection in a computing system, the method comprising:
detecting an error condition in a computing system by a detection engine that includes an interceptor positioned in a data path and a detector configured to perform threat detection, wherein the error condition impacts communication between the interceptor and the detector;
entering an error handling mode, by the interceptor, based on the error condition, wherein interceptor is configured to store tracking data during the error handling mode associated with IOs (Input/Outputs) in the data path;
resuming the communication between the interceptor and the detector when the error condition is resolved; and
performing a catch-up operation using the tracking data such that the detector performs the threat detection based on the tracking data.

2. The method of claim 1, wherein the error condition includes an increase in latency, bandwidth reduction, failure of the detector, network failure, or combinations thereof, wherein the threat detection is configured to detect ransomware.

3. The method of claim 1, wherein the error handling mode comprises a tracking mode, further comprising entering the tracking mode only when the error condition lasts longer than a predetermined period of time or after a predetermined number retries have failed.

4. The method of claim 1, wherein the error handling mode comprises a tracking mode, wherein the tracking mode comprises a stream tracking mode, wherein IOs are tracked in a stream by the interceptor, wherein the stream stores pairs that each include a location and a length.

5. The method of claim 1, wherein the error handling mode comprises a tracking mode, wherein the error tracking mode comprises a bitmap tracking mode, wherein IOs are tracked by the interceptor in a bitmap stored by the interceptor.

6. The method of claim 1, wherein the error handling mode comprises a tracking mode, wherein the tracking mode comprises a stream tracking mode that uses a stream to track IOs and a bitmap tracking mode that uses a bitmap to track the IOs, wherein the stream tracking mode transitions to the bitmap tracking mode based on resource availability.

7. The method of claim 1, wherein read IOs and write IOs are tracked separately by the error handling mode.

8. The method of claim 1, wherein the error handling mode comprises a tracking mode configured to generate tracking data related to the IOs during the error condition, wherein the catch-up operation includes sending tracking data related to read IOs to the detector for the malware detection, wherein the tracking data is formatted for the detector.

9. The method of claim 8, wherein the catch-up operation includes generating a payload for tracking data related to the read IOs.

10. The method of claim 1, wherein the error handling mode comprises a tracking mode configured to generate tracking data related to the IOs during the error condition, wherein the tracking data includes metadata and data read from locations on a target identified from the tracking data.

11. A non-transitory storage medium having stored therein instructions that are executable by one or more hardware processors to perform operations for protecting a computing system, the operations comprising:
detecting an error condition in a computing system by a detection engine that includes an interceptor positioned in a data path and a detector configured to perform threat detection, wherein the error condition impacts communication between the interceptor and the detector;
entering an error handling mode, by the interceptor, based on the error condition, wherein interceptor is configured to store tracking data during the error handling mode associated with IOs (Input/Outputs) in the data path;
resuming the communication between the interceptor and the detector when the error condition is resolved; and
performing a catch-up operation using the tracking data such that the detector performs the threat detection based on the tracking data.

12. The non-transitory storage medium of claim 11, wherein the error condition includes an increase in latency, bandwidth reduction, failure of the detector, network failure, or combinations thereof, wherein the threat detection is configured to detect ransomware.

13. The non-transitory storage medium of claim 11, wherein the error handling mode comprises a tracking mode, further comprising entering the tracking mode only when the error condition lasts longer than a predetermined period of time or after a predetermined number retries have failed.

14. The non-transitory storage medium of claim 11, wherein the error handling mode comprises a tracking mode, wherein the tracking mode comprises a stream tracking mode, wherein IOs are tracked in a stream by the interceptor, wherein the stream stores pairs that each include a location and a length.

15. The non-transitory storage medium of claim 11, wherein the error handling mode comprises a tracking mode, wherein the error tracking mode comprises a bitmap tracking mode, wherein IOs are tracked by the interceptor in a bitmap stored by the interceptor.

16. The non-transitory storage medium of claim 11, wherein the error handling mode comprises a tracking mode, wherein the tracking mode comprises a stream tracking mode that uses a stream to track IOs and a bitmap tracking mode that uses a bitmap to track the IOs, wherein the stream tracking mode transitions to the bitmap tracking mode based on resource availability.

17. The non-transitory storage medium of claim 11, wherein read IOs and write IOs are tracked separately by the error handling mode.

18. The non-transitory storage medium of claim 11, wherein the error handling mode comprises a tracking mode configured to generate tracking data related to the IOs during the error condition, wherein the catch-up operation includes sending tracking data related to read IOs to the detector for the threat detection, wherein the tracking data is formatted for the detector.

19. The non-transitory storage medium of claim 18, wherein the catch-up operation includes generating a payload for tracking data related to the read IOs.

20. The non-transitory storage medium of claim 11, wherein the error handling mode comprises a tracking mode configured to generate tracking data related to the IOs during the error condition, wherein the tracking data includes metadata and data read from locations on a target identified from the tracking data.
